(19) United States
(12) Patent Application Publication
(10) Pub. No.: US 2025/0132846 A1
(43) Pub. Date: Apr. 24, 2025

(54) SYSTEM AND METHOD FOR AI AND ML BASED CSI PREDICTION IN NR

(71) Applicant: Samsung Electronics Co., Ltd., Gyeonggi-do (KR)

(72) Inventors: Hamid SABER, San Diego, CA (US); Jung Hyun BAE, San Diego, CA (US)

(21) Appl. No.: 18/924,473

(22) Filed: Oct. 23, 2024

Related U.S. Application Data
(60) Provisional application No. 63/592,287, filed on Oct. 23, 2023.
(60) Provisional application No. 63/598,262, filed on Nov. 13, 2023.
(60) Provisional application No. 63/569,313, filed on Mar. 25, 2024.
(60) Provisional application No. 63/640,326, filed on Apr. 30, 2024.

(51) Int. Cl. H04B 17/373; H04L 5/00; H04W 24/10

(52) U.S. Cl. CPC H04B 17/373; H04L 5/0051; H04W 24/10

(57) ABSTRACT

A system and a method are disclosed for artificial intelligence (AI) and machine learning (ML) based channel state information (CSI) prediction. The method includes receiving, by a user equipment (UE), a CSI reference signal (RS) from a base station; storing, by the UE, a series of CSI measurements corresponding to the received CSI-RS; receiving, by the UE, a CSI report configuration including an indication that artificial intelligence machine learning (AIML) CSI prediction is applied; in response to receiving the indication that AIML CSI prediction is applied, generating, by the UE, a predicted CSI based on the stored CSI measurements using a trained AIML model; and transmitting, by the UE, the predicted CSI to the base station.

### CROSS-REFERENCE TO RELATED APPLICATION

This application claims the priority benefit under 35 U.S.C. § 119 (e) of U.S. Provisional Application No. 63/592,287, filed on Oct. 23, 2023, Provisional Application No. 63/598,262, filed on Nov. 13, 2023, Provisional Application No. 63/569,313, filed on Mar. 25, 2024, and Provisional Application No. 63/640,326, filed on Apr. 30, 2024, each of the disclosures of which are incorporated by reference in their entireties as if fully set forth herein.

### TECHNICAL FIELD

The disclosure generally relates to wireless communication systems. More particularly, the subject matter disclosed herein relates to improvements to channel state information (CSI) prediction using artificial intelligence (AI) and machine learning (ML) techniques in new radio (NR) networks.

### SUMMARY

In wireless communication systems, such as NR networks (such as fifth generation (5G) mobile network technology), accurate and timely CSI feedback is beneficial for efficient downlink transmission. CSI enables a base station (gNB) to optimize beamforming, scheduling, and resource allocation based on current channel conditions. However, in high-mobility environments, the CSI becomes outdated between the time it is measured by the user equipment (UE) and the time it is used by the gNB for scheduling, a phenomenon known as CSI aging. This degradation of CSI accuracy leads to a reduction in network throughput and spectral efficiency.

To solve this problem, some solutions rely on autoregressive (AR) models or other linear prediction techniques that attempt to estimate the future CSI based on past measurements. Additionally, feedback mechanisms have been designed to compensate for outdated CSI by increasing the frequency of CSI reporting, which, however, results in a significant increase in overhead and power consumption.

One issue with the above approach is that linear prediction models, like AR, fail to capture the complex temporal correlations in the wireless channel, especially in rapidly changing environments, leading to suboptimal prediction accuracy. Furthermore, increasing the frequency of CSI reporting to mitigate the aging problem creates excessive signaling overhead and depletes UE battery life. As a result, these methods are inefficient in handling the dynamic and non-linear nature of wireless channels, particularly in high-mobility scenarios.

To overcome these issues, systems and methods are described herein for AI and/or machine learning ML-based CSI prediction (for convenience of description, the term “AIML” is used herein to mean “AI and/or ML”). These methods utilize deep learning models, such as 3D-CNNs, trained on past CSI measurements to predict future CSI more accurately. The AIML model can process historical CSI data over multiple time intervals, learning complex temporal correlations. This prediction may be performed at the UE side and transmitted to the gNB using enhanced CSI reporting configurations. The proposed methods and systems also include mechanisms for managing the lifecycle of AIML models, including training, validation, and inference, to ensure consistent prediction performance as network conditions evolve.

The above approaches improve on previous methods because the AIML model can adapt to non-linear changes in channel conditions and reduce the error in CSI prediction, particularly in high-mobility environments. This results in better beamforming accuracy, reduced signaling overhead, and improved overall network performance. Furthermore, by using AIML at the UE side, solutions proposed herein optimize the trade-off between CSI reporting frequency and prediction accuracy, significantly enhancing spectral and energy efficiency.

In an embodiment, a method comprises receiving, by a UE, a CSI reference signal (RS) from a base station; storing, by the UE, a series of CSI measurements corresponding to the received CSI-RS; receiving, by the UE, a CSI report configuration including an indication that AIML CSI prediction is applied; in response to receiving the indication that AIML CSI prediction is applied, generating, by the UE, a predicted CSI based on the stored CSI measurements using a trained AIML model; and transmitting, by the UE, the predicted CSI to the base station.

In an embodiment, a UE comprises a memory device; and a processor configured to execute instructions stored on the memory device. The instructions cause the processor to receive a CSI-RS from a base station; store a series of CSI measurements corresponding to the received CSI-RS; receive, by the UE, a CSI report configuration including an indication that AIML CSI prediction is applied; in response to receiving the indication that AIML CSI prediction is applied, generate a predicted CSI based on the stored CSI measurements using a trained AIML model; and transmit the predicted CSI to the base station.

### BRIEF DESCRIPTION OF THE DRAWING

In the following section, the aspects of the subject matter disclosed herein will be described with reference to exemplary embodiments illustrated in the figures, in which:

FIG. 1 is a flowchart illustrating machine learning stages, according to an embodiment;

FIG. 2 is a block diagram illustrating a physical uplink control channel (PUCCH) processing chain, according to an embodiment;

FIG. 3 is a table comparing generating and reporting CSI in NR in long term evolution (LTE) to NR, according to an embodiment;

FIG. 4 is a diagram illustrating antenna port layout patterns, according to an embodiment;

FIG. 5 is a block diagram illustrating an example of an AIML-driven CSI prediction scheme, according to an embodiment;

FIG. 6 is a diagram illustrating an example of using an observation window and prediction window in AIML CSI prediction, according to an embodiment;

FIG. 7 is a flowchart illustrating a method for AIML based CSI prediction, according to an embodiment;

FIG. 8 is a block diagram of an electronic device in a network environment, according to an embodiment; and

FIG. 9 is a block diagram illustrating a UE and a gNB included in an AIML prediction system, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

A “CSIRS” (or “CSI-RS”) as used herein refers to a reference signal transmitted by a base station and used by a UE for channel estimation and reporting CSI. Some examples of CSI RS are a CSI-RS for demodulation reference, channel estimation, and CSI acquisition.

“CSI measurements” as used herein refers to the measurements derived from received CSI reference signals, which are used for generating CSI reports. Some examples of “CSI measurements” are estimated channel coefficients, signal-to-noise ratio (SNR), and interference levels.

A “predicted CSI” as used herein refers to a CSI value that is generated based on stored CSI measurements using a prediction model, which can include AI and/or ML techniques. Some examples of “predicted CSI” are predicted channel quality indicators (CQI), rank indicators (RI), and precoding matrix indicators (PMI).

A “CSI report configuration” as used herein refers to a set of parameters provided to the UE that define how and when to generate and transmit a CSI report to the network. Some examples of “CSI report configuration” are aperiodic CSI reporting configurations, semi-persistent CSI configurations, and AIML-based CSI reporting configurations.

A “capability report” as used herein refers to a message transmitted by the UE that indicates the device's capabilities, such as supported CSI processing capabilities, a maximum number of active functionalities, or AIML model capabilities. Some examples of “capability report” are reports indicating CPU limitations, AIML model compatibility, and supported CSI report configurations.

The present disclosure relates to systems and methods for CSI prediction in NR wireless communication networks, particularly applying AIML techniques. In modern wireless systems, such as 5G, CSI is used for optimizing network performance by enabling accurate beamforming, scheduling, and resource allocation. However, in high-mobility environments, where channel conditions change rapidly, the delay between CSI measurement and its use by the network, often referred to as CSI aging, can severely degrade performance. This disclosure presents solutions that address the limitations of traditional prediction methods by using advanced AIML models to predict future CSI with improved accuracy.

Unlike other methods that rely on linear prediction techniques such as AR models, one or more embodiments of the present disclosure uses deep learning architectures implemented via one or more neural processing units (NPUs), including 3D CNNs, which are capable of capturing complex, non-linear temporal correlations in the wireless channel. The AIML model may be trained to recognize patterns in the channel measurements, allowing it to predict future CSI with minimal error, even in rapidly changing environments. These improvements reduce the need for frequent CSI feedback, lowering signaling overhead and improving energy efficiency in UE.

By integrating AIML models at the UE side, solutions proposed herein enhance the ability to adapt to dynamic network conditions and ensure more accurate CSI prediction, which leads to better network throughput and reliability. One or more embodiments may also include methods for managing the lifecycle of AIML models, such as data collection, training, validation, and inference, ensuring that the prediction models remain accurate over time. Accordingly, some or all of the embodiments disclosed herein represent a significant improvement over existing techniques by optimizing CSI feedback, reducing network overhead, and ensuring more reliable performance in high-mobility scenarios.

AIML techniques are widely used techniques for inferring complex functions of data which can be difficult to obtain through other methods. Many samples of data may be provided to the learning-enabled device or machine, which in turn applies one of the various AIML techniques to learn how to determine those complex functions using the provided data samples.

An AIML procedure may allow a learning-enabled device to learn a function ƒ(x) of a data sample input x. This procedure can include two distinct phases:
Training phase: in this phase, the learning-enabled device uses a large data set, referred to as the “training data set”, which includes i) data samples, and ii) the outcome of the function ƒ(x) for every sample in the training data set. In this phase, the learning-enabled device may apply training techniques which allows it to learn an approximate relation which can closely behave as the function ƒ(x).
Testing phase/application phase: in this phase, the learning-enabled device may use the approximate function that has been obtained via the training phase to determine the function value f(x) of other data samples which can be different than the samples in the training phase.

The success/performance of the AIML procedure may rely on the premise that a sufficiently large training data set is available, which would then include sufficient information about the function ƒ(x) and thus allow the learning-enabled device to obtain a sufficient approximation of the function ƒ(x) through the training phase.

AIML techniques may be used in different applications, including applications in wireless communication. An example of an AIML application in wireless communication is the process of CSI compression.

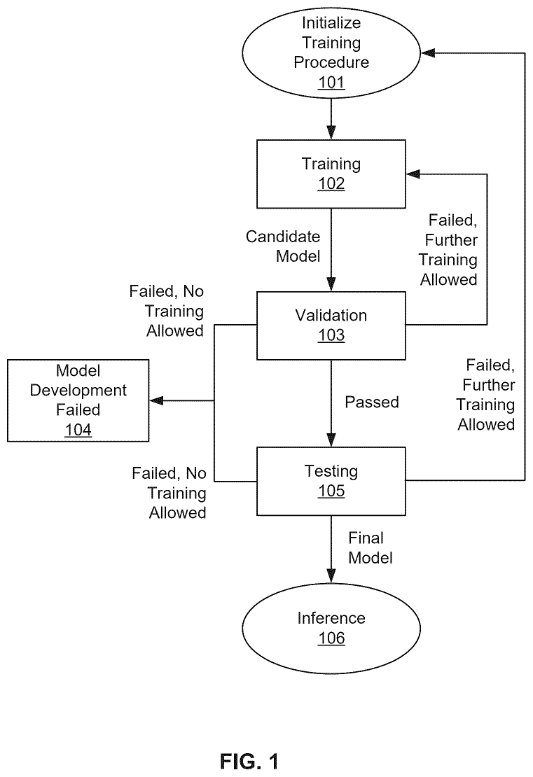

FIG. 1 is a flowchart illustrating machine learning stages, according to an embodiment.

The stages of AIML model development can be broadly categorized into distinct phases, each of which is illustrated in FIG. 1, which outlines the general flow for the development, validation, and deployment of an ML model. This flowchart represents the entire lifecycle of the model, starting from the initialization of the training procedure and progressing through training, validation, testing, and inference.

Referring to FIG. 1, the training procedure is initiated in step 101. During the training phase in step 102, the ML model is trained using a dataset including a large number of samples. The objective is to allow the model to learn from the data and configure necessary parameters such as neural network weights and hyperparameters. The training phase can be time-consuming, depending on the size and complexity of the dataset. The training itself can take the form of either full training, where the model is being trained from scratch using a new dataset, or partial training, where the model has been previously trained but needs updating due to new data or performance degradation. In the latter case, the dataset can be a mix of new and previously used data.

Once training is completed, the model enters the validation stage in step 103. Validation may help assess whether the trained model is suitable for the task at hand. As shown in FIG. 1, if the candidate model fails validation, further training may be necessary by returning to step 102. Validation may also trigger additional training if performance thresholds are not met. The system applies specific criteria to determine if the validation is successful, such as classification accuracy or minimum mean square error (MMSE). If validation fails repeatedly or the number of validation steps exceeds a predefined threshold, the entire development procedure may be declared a failure in step 104, and model development stops at this point. Otherwise, if validation fails but further training is still allowed, then the process may return to the training step 102.

Following successful validation, the model proceeds to the testing stage in step 105, assuming it has passed the validation criteria. During testing, the trained model is evaluated to ensure it performs as expected in real-world scenarios. If the model successfully passes testing, it is then deployed for inference in step 106, where the model is used in actual applications to perform the target task, such as CSI prediction in wireless communication. However, if the testing fails, the model may return to step 101 to initialize the training procedure or, in some cases, the model development process is declared unsuccessful and terminated. The success criteria in the testing phase are similar to those in validation, though the specific performance metrics may differ slightly between these two stages.

Once the model has passed both validation and testing, it moves to the final phase of inference, where it is deployed for use in live environments, performing the task it was designed for, such as predicting CSI in real-time applications.

In NR, a UE may be configured to handle various downlink and uplink transmissions to and/or from the base station (gNB). Downlink transmissions may involve the reception of data and control information by the UE from the gNB. Specifically, user data can be delivered through the physical downlink shared channel (PDSCH), which operates using allocated time and frequency resources. The medium access control (MAC) layer of the UE manages this user data, delivering it to the corresponding layers within the UE's protocol stack. The physical layer may be responsible for processing the signals received on the PDSCH, feeding them through a PDSCH processing chain, which then outputs the data for higher-layer processing in the MAC. In addition to user data, the UE may also receive control information from the gNB via the physical downlink control channel (PDCCH). The control information, known as downlink control information (DCI), is processed through a PDCCH processing chain at the gNB and subsequently transmitted to the UE.

Conversely, uplink transmissions may allow the UE to send data and control signals back to the gNB. For user data, the UE may utilize the physical uplink shared channel (PUSCH), while control data, referred to as uplink control information (UCI), is transmitted via the PUCCH. The MAC layer of the UE may prepare the data to be sent over the PUSCH, and the UCI may be processed through a PUCCH processing chain before being transmitted.

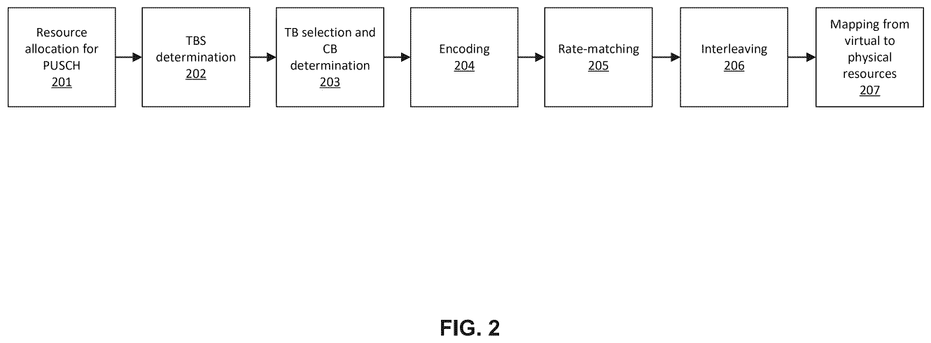

FIG. 2 is a block diagram illustrating a PUCCH processing chain, according to an embodiment. FIG. 2 depicts the typical flow for processing uplink and downlink shared channels.

Referring to FIG. 2, the process begins with the resource allocation for the PUSCH in step 201, where the transmitter is assigned specific resources for the physical shared channel transmission. These resources may be allocated either dynamically, through DCI signaling, or semi-statically, such as via configured grant (CG) PUSCH transmission. The resources allocated for transmission may include orthogonal frequency division multiplexing (OFDM) symbols and subcarriers (SCs), which can be contiguous or non-contiguous in both time and frequency.

A transport block size (TBS) determination step 202 may follow and ensure that the data payload size is correctly selected for the available resources. The next step 203, transport block (TB) selection and code block (CB) determination, involves selecting the data blocks that will be transmitted. These blocks are then passed through the encoding stage in step 204, where error correction coding, such as turbo coding or low density parity check (LDPC) coding, is applied. After encoding, the data is rate-matched (RM) to fit the available resources in step 205, and subsequently interleaved in step 206 to ensure better resistance to transmission errors. Finally, the interleaved data is mapped from virtual resources to physical resources in step 207, and is ready for transmission on the assigned OFDM symbols and subcarriers.

The CSI generator in NR systems may calculate various indicators for communication between the UE and the serving base station (gNB). These indicators may include the CQI, which is linked to the modulation and coding scheme (MCS) used for adaptive modulation and frequency-selective resource allocation, as well as the PMI, which is used for closed-loop multiple-input multiple-output (MIMO) systems. Another parameter calculated is the CSI-RS resource indicator (CRI), which assists in selecting the appropriate CSI-RS resource, while the RI corresponds to the number of effective transmission layers.

In NR, a dual PMI codebook structure may be adopted, known as Type-I codebook, which provides finer spatial domain granularity, with exceptions for 2-antenna setups. For large-scale antenna systems, such as in elevation beamforming (EB) and full-dimension MIMO (FD-MIMO), the CRI may be used similarly to its application in LTE, wherein the CSI-RS resource is selected before determining CQI, PMI, and RI. Additionally, NR may employ a more advanced Type-II codebook, which allows for improved spatial multiplexing and efficient use of massive MIMO arrays, enabling greater multi-user (MU) support. To further refine the feedback, periodic, semi-persistent (SP), or aperiodic (AP) CSI reporting modes may be employed, providing sub-band level CQI and PMI for better frequency domain granularity. A hybrid CSI feedback mechanism may also be introduced to optimize beamforming and other operations, particularly in scenarios where accurate CSI feedback may not be feasible, such as in high-speed mobility. In such cases, semi-open loop operation may be supported to increase diversity gain, which may be preferable to beamforming gains.

The removal of cell-specific reference signals (CRS) in NR has shifted the responsibility of CSI generation to be fully reliant on CSI-RS. The UE may measure downlink channel conditions using CSI-RS to estimate channel characteristics and noise variance for generating accurate CSI. Unlike LTE, where CSI configurations are more rigid and tied to each feature, NR adopts a flexible configuration framework. For example, LTE's coordinated multipoint (COMP) and FD-MIMO requires new CSI configurations, especially for Class B FD-MIMO setups. In contrast, NR embraces a more adaptable CSI configuration that supports all functionalities introduced so far.

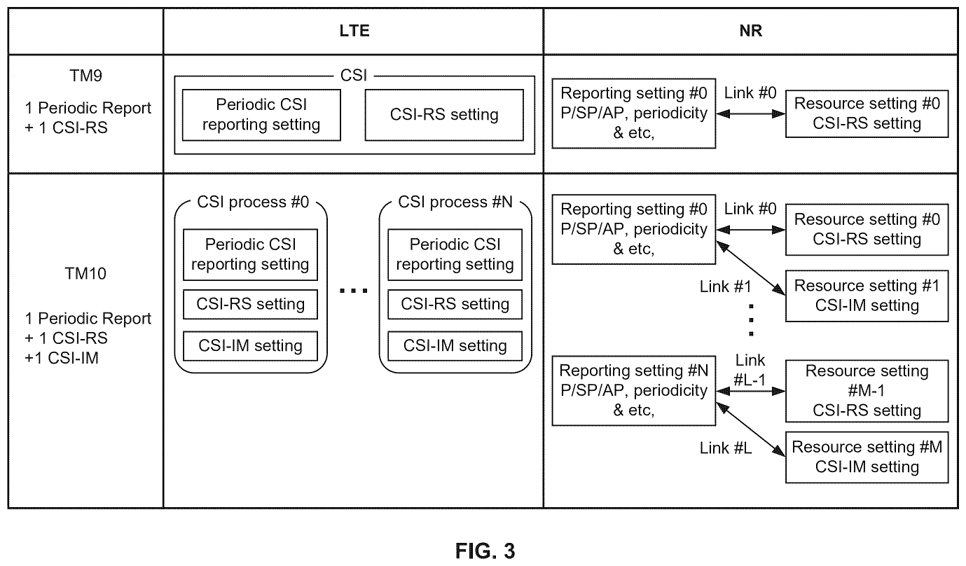

FIG. 3 is a table comparing generating and reporting CSI in NR in LTE to NR, according to an embodiment.

Referring to FIG. 3, the process of generating and reporting CSI in NR is more flexible than in LTE. In LTE, under transmission mode 9 (TM9), one periodic CSI report corresponds to one CSI-RS setting. However, in NR, the reporting settings, which include parameters such as periodicity, SP reporting, and AP reporting, are linked to multiple resource settings, such as CSI-RS settings. For example, if a TM9 FD-MIMO Class B CSI report is needed in NR, the network configures the reporting settings, specifying indicators like CRI, RI, PMI, and CQI. These reporting settings may be linked to one or more resource settings, which may include up to 8 CSI-RS resources and are connected via a linking process. If the network requires a periodic CSI report for a selected CRI, it configures the periodicity and reporting type and links these reporting settings to the appropriate CSI-RS resource setting.

In NR, this framework can be expanded in scenarios such as transmission mode 10 (TM10), where multiple CSI processes are supported. Each CSI process, as seen in FIG. 3, can include separate CSI-RS and CSI-interference measurement (CSI-IM) settings, creating more flexible and dynamic CSI feedback loops. Additionally, NR may adopt a dual PMI structure, where the precoding matrix is split into two components: the wideband precoder (W1) and the subband precoder (W2). This dual-stage precoding enables more precise beamforming and better spatial multiplexing in complex MIMO environments. The wideband precoder operates over a broader frequency range, handling general beamforming, while the subband precoder focuses on specific frequency subbands, enabling precise spatial multiplexing and adjustments to beamforming.

A codebook may be used by various embodiments to provide a structured framework for CSI feedback and to enable the efficient use of precoding techniques in 5G NR systems. Various embodiments may integrate AIML-based CSI prediction to enhance and optimize the feedback process, particularly in high-mobility environments where channel conditions are dynamic. The codebook can help organize and structure the feedback information that the gNB (base station) uses to improve beamforming and MIMO operations.

According to various embodiments, AIML CSI prediction may use the codebook to predict future CSI values, such as PMI, RI, and CQI. The dual-codebook structure allows for flexible and efficient CSI feedback.

In addition, various embodiments disclosed herein may use both Type-I and Type-II codebooks to support different types of antenna configurations. The Type-I codebook is typically used for systems with fewer antennas and provides the necessary structure for predicting CSI in terms of rank, precoding matrix, and CQI. In contrast, the Type-II codebook is designed for massive MIMO systems and is particularly well-suited for elevation beamforming and FD-MIMO setups with large antenna arrays. The structure of the Type-II codebook may enable the AIML prediction model to manage a higher number of transmission layers and benefit from multi-user spatial multiplexing.

In NR, CSI-RS may be used to measure downlink channel conditions, and the CSI-RS resource can be selected before the prediction of PMI, RI, and CQI. The CRI may be included in the feedback to indicate which CSI-RS resource was used for the channel measurement, and the codebook structure may facilitate this feedback process. Additionally, the eType II Doppler domain (DD) compression codebook may be used, which compresses CSI in the time domain, as well as in the spatial and frequency domains. Various embodiments disclosed herein may use AIML-based prediction models, which use the codebook structure to compress and predict CSI, addressing the issue of CSI aging (e.g., the delay between CSI measurement and scheduling that results in outdated feedback).

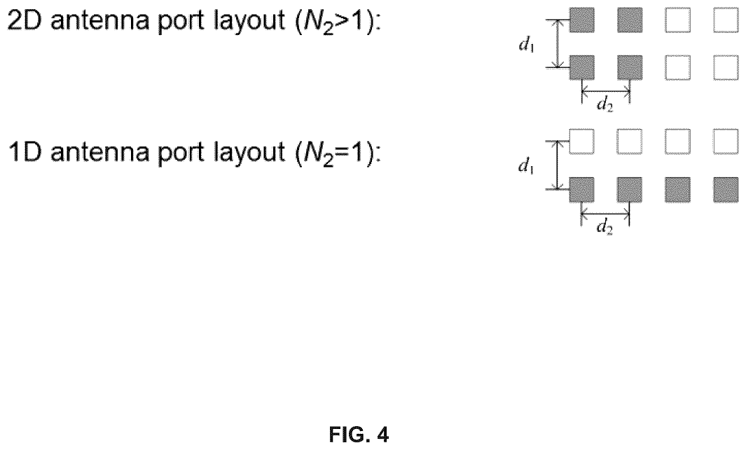

FIG. 4 is a diagram illustrating antenna port layout patterns, according to an embodiment.

Referring to FIG. 4, a 2D antenna port layout is shown for when N₂>1, and a 1D antenna port layout is shown for when N₂=1, where Nis the number of antenna port dimensions.

In massive MIMO systems, high-resolution CSI feedback from the UE to the gNB may enable efficient multi-user MIMO transmission. Accurate CSI feedback may improve overall system throughput by allowing the gNB to optimize resource allocation and transmission schemes. However, in high-mobility scenarios, massive MIMO systems are particularly vulnerable to channel aging. This can lead to a situation where the CSI used for scheduling may become outdated, resulting in suboptimal downlink performance.

AI-based CSI prediction in the time domain can reduce the error associated with CSI predictions compared to non-AI methods. The neural network used in AI-based predictions may learn the temporal correlation of the wireless channel, allowing it to predict the channel conditions at a future time with higher accuracy.

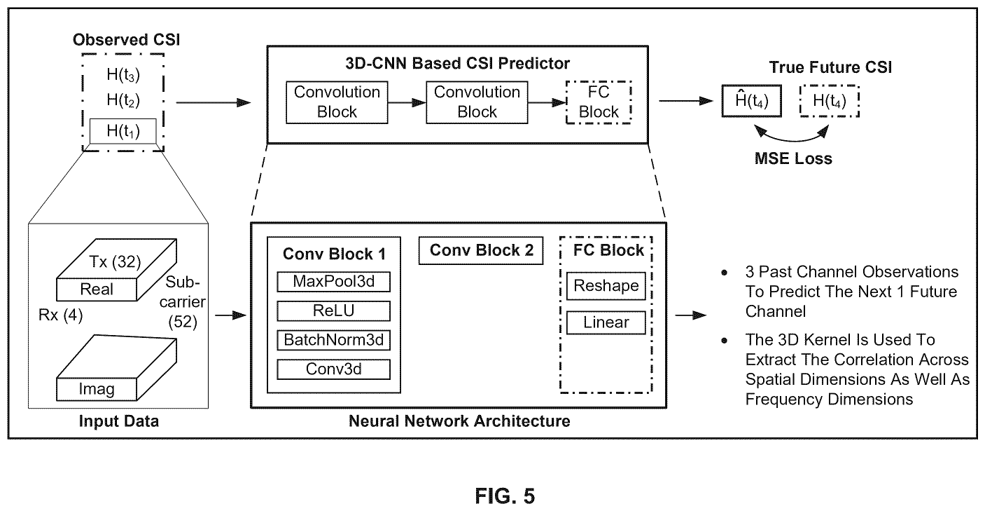

FIG. 5 is a block diagram illustrating an example of an AIML-driven CSI prediction scheme, according to an embodiment.

Referring to FIG. 5, the UE stores its channel observations, denoted as H (tₖ), at each time instant tₖ in a buffer (where k corresponds to particular time instance), which holds multiple past channel observations. At a given time instant, such as t₃, the UE retrieves all the stored channel observations in its buffer, including H (t₃), H (t₂), and H (t₁). These observations are then passed to a 3D convolutional neural network (3D-CNN), which processes the data to predict the future channel condition at the next time instant, H (t₄), denoted as H (t₄). This prediction allows the gNB to make more accurate scheduling decisions in high-mobility environments where channel conditions can change rapidly.

In order to ensure optimal performance of the CSI prediction model, a certain level of consistency in the statistical distribution of the CSI matrices used in the training set should be maintained. One factor that can introduce statistical heterogeneity within these CSI matrices is the interference caused by neighboring cells or intra-cell multi-user interference. Typically, at the UE side, the channel corresponding to a signal, such as the CSI-RS, is estimated and then normalized based on the covariance matrix of the additive, potentially colored, noise. This normalized channel matrix is then used for CSI computation. If the CSI matrices are affected by varying interference statistics, such as different interference precoders, it can result in statistical heterogeneity within the training set.

Although a primary responsibility for ensuring low statistical heterogeneity among the CSI matrices in the training set falls on the gNB, certain restrictions may be explicitly specified to meet this requirement. For instance, the UE may be prohibited from including CSI matrices corresponding to different physical resource groups (PRGs) in the same training set. This restriction can be generalized to any arbitrary set of resource elements within which the gNB can ensure statistical homogeneity. For example, the UE may be configured with a group of RES, referred to as AIML physical resource groups (AIML-PRGs), where the interference precoder is not expected to change within the AIML PRG. In this scenario, the UE is not permitted to include CSI matrices from different AIML PRGs within the same training set. A similar restriction may be applied to the testing phase, where the UE is not expected to encode CSI matrices from different PRGs using the same encoder.

An alternative approach would involve grouping CSI matrices from multiple PRGs together and using them as input for both the training and testing phases. However, if the matrices corresponding to different PRGs experience varying levels of interference, this could lead to different distributions for the CSI matrices, resulting in a less effective training process. In an embodiment, the UE may not be expected to be configured with a training set that combines CSI matrices from different PRGs. In other words, the UE should avoid encoding CSI matrices from different PRGs simultaneously as a single input to the encoder, thereby preventing inconsistencies in the statistical distribution of the data used for model training and testing.

When the UE is required to update the encoder model based on an online training set, either collected through channel estimation or reconfigured via RRC or MAC-CE activation, the UE should have a sufficient amount of time to complete the model update, taking into consideration the processing time needed for such operations. This requirement may be applied irrespective of whether the UE will share its updated model with the gNB.

If the online training set is collected through channel estimation performed by the UE, the UE may not be expected to update the model until a predefined number of symbols N_{AIML,upadte} have elapsed from the last symbol of the most recent CSI-RS used for the online training set. Similarly, if the UE is configured to report the updated model to the gNB, it should not report the model to the gNB earlier than N_{AIML,report} symbols from the last symbol of the latest CSI-RS used in the training set.

In cases where the training set is reconfigured through RRC commands or activated through a MAC-CE command, the UE may not be expected to update or report its updated encoder model earlier than a specified number of symbols after the completion of the corresponding RRC reconfiguration or from the reception of the MAC-CE activation command. This ensures that the UE has adequate time to complete the processing required for the model update before it performs any further operations, such as transmitting the updated model to the gNB.

As used herein, the term “CSI matrix” may refer to the CSI information corresponding to an RE, or a group of REs that the UE would compress. However, the term “CSI matrix” may also be used as a general descriptor and can be further elaborated with more technical details. For a MIMO channel, the capacity-achieving distribution may be a Gaussian distribution with potentially different power allocations across the transmit antennas. If a channel matrix H is represented as H_{r×t}=UΣV^{H}, the capacity-achieving distribution may be obtained by first transforming x into \tilde{x}=Vx, where x is an independent and identically distributed Gaussian random vector with zero mean and unit variance. Each element of

$$\tilde{x} = [ \begin{matrix}{\tilde{x}}_{1} \\ ⋮ \\ {\tilde{x}}_{t}\end{matrix} ]$$

may then be multiplied by a corresponding power allocation, determined by the water-filling algorithm (allocating more power to channels with better signal quality).

The power allocation for the i-th channel can be denoted as Pᵢ, i=1, . . . , t, where Pᵢ_values are derived from the singular value decomposition (SVD) of the channel matrix H. Thus, the complete information required at the gNB may include both the right singular value matrix V and the singular values themselves. In general, the CSI matrix can be represented as the channel matrix H, as the concatenation of V and the singular values, or as the matrix U.

The UE may be configured to report any of these defined CSI matrices through RRC (re)-configuration, MAC-CE commands, or dynamically through DCI. For instance, when the UE is configured to report V and the singular values, it can also be instructed to only report the singular values, if required. When the UE is configured to report a specific type of CSI matrix, the training set and loss function for model training should be defined based on the applicable CSI matrix. For example, when the UE is configured to report the V matrix, the training set may include the V matrices derived from the estimated channel matrices. In this case, the loss function may be defined based on the difference between the V matrix input to the encoder and the reconstructed V matrix at the decoder's output.

Federated learning (FL) is a system that enables a global model to be developed at a central server through the aggregation of locally trained models from multiple distributed nodes. Each node, connected to the central server, performs individual learning using its local data and subsequently shares its learned model with the server. The server then processes the received models, for example, by averaging them, to generate a final global model. This approach is advantageous for maintaining data privacy, as it allows the nodes to contribute to model training without sharing their actual data with the server.

In the context of CSI compression, the gNB can be considered the central server, while the various UEs connected to the gNB act as the model updating nodes. Each UE may have its own unique training set, which could have the same or different statistical distributions compared to other UEs. When the distributions are similar across UEs, each UE may update the model using its local training set and then shares the resulting model with the gNB. The gNB may perform operations such as averaging on the collected models to obtain a final model. This final model, which is based on the union of all the training sets from the participating UEs, may have better performance than any of the individual models. The gNB can then distribute this final model back to the UEs, improving the overall CSI compression performance.

In cases where different UEs have distinct data distributions, FL helps capture these variations through the shared models. This enables the FL framework to develop a more robust model that considers different channel environments observed by the UEs. Accordingly, FL allows for the development of a comprehensive model that accounts for diverse training conditions across the network.

Within the FL framework, the gNB can configure a group of UEs to form an FL group. All UEs in this group may be configured with the same encoder and decoder architecture, meaning that while the trained weights may differ between UEs, the network structure (including the number of layers, units, activation functions, and other defining parameters) may remain identical across all UEs. Additionally, the input size and format for both the encoder and decoder models may be the same for all UEs in the group. For example, if the input to the encoder is configured as the channel matrix or the singular value matrix V, this input type may remain consistent across all UEs in the group. Scenarios where different UEs have different input types (e.g., some using the channel matrix and others using the singular value matrix) may not be supported within the FL framework.

The gNB can instruct the UEs to update their models and share the updates using signaling mechanisms such as RRC, DCI, or MAC-CE commands. Not all UEs in the FL group may be required to participate in the model update procedure at the same time, providing flexibility in the training process. The gNB may also send information regarding training, hyperparameters, and other FL aspects via a group-common DCI. Each UE in the FL group can be configured with its specific portion of the DCI through RRC signaling, ensuring that all UEs in the group receive the relevant information for their training and model update procedures.

Different UEs may have varying capabilities in terms of implementing neural networks. For example, some UEs may be capable of supporting CNNs but may not support recurrent neural networks (RNNs), and vice versa. To address these variations, UEs can report their capabilities in supporting specific types of neural network architectures. This may include the network type, such as CNNs, RNNs, or other architectures like gated recurrent unit (GRU), long short-term memory (LSTM), or transformers, as well as any other relevant aspects that reflect the UE's restrictions and capabilities for applying an encoder model.

A set of restrictions reported by the UE may include the following information: the type of network architecture (e.g., CNN, RNN, and/or a specific type of RNN), aspects related to the size of the model (such as the number of layers, the number of input/output channels in a CNN, and/or the number of hidden states in an RNN), and/or any other structural limitations. Based on these reported capabilities, the UE may not be expected to train or test an encoder model if it violates any of the constraints or exceeds its declared capabilities.

This expectation may be implemented regardless of the applicable framework or the location of model training and inference. For example, in a framework where the gNB pre-trains an encoder and decoder and subsequently shares them with the UE, the UE may not anticipate the received encoder model to exceed its capabilities. In another framework, one or multiple pairs of encoders and decoders may be trained offline and specified within the NR configuration. In this scenario, the UE should not expect to support any model that violates its declared capabilities.

It is also possible for the UE to report its capabilities through capability signaling and explicitly declare which of an encoder/decoder pair, an encoder only, or a decoder only it can support. The gNB can then indicate to the UE which is applicable based on the UE's capabilities. This indication can be communicated via system information, a RRC configuration, or dynamic signaling through DCI. This process can ensure that the encoder and decoder models used by the UE remain within its computational and structural capabilities, leading to consistent and efficient performance across different network scenarios.

In certain frameworks, the UE may be expected to perform online training by collecting new training examples dynamically, either on-the-fly or based on pre-provisioned data, and subsequently updating its model(s). This process is referred to as fine-tuning and allows the UE to adapt its models to changing network conditions or environments.

The capability to perform online training and fine-tuning may be declared by the UE as part of its capability signaling. A UE that supports online training may also be required to report any restrictions related to the supported model structures. These restrictions may include the type of neural network architecture, the number of layers, the number of hidden states, or other structural limitations.

If multiple models are specified, or if models are identified offline with associated identifications (IDs) and/or model description information, the UE may declare its capability by indicating which models or IDs it can support. This allows the gNB to determine which models are applicable for use by the UE and to configure the UE accordingly.

Multiple CSI prediction models can be trained and deployed at either the UE or the gNB. The use of multiple models can be specifically optimized to handle different scenarios. These scenarios may arise from varying channel environments, which can lead to differences in the statistical distribution of the training and testing datasets. By tailoring each model to a particular environment or use case, the performance of the CSI prediction can be improved.

In addition, multiple models can accommodate input data with different dimensionalities. For example, different models may be used to process varying antenna configurations or distinct channel conditions, ensuring that each model is designed to maximize performance for its specific input. While having a single, unified model can mitigate the complexity associated with managing multiple models, it may come at the cost of degraded compression performance when applied to diverse scenarios. Conversely, using case-specific models allows for direct optimization tailored to each case, but increases memory usage and implementation complexity at the UE or gNB.

The trade-off between using a single model versus multiple models may depend on the specific application and the resources available at the UE or gNB. In situations where memory and processing capabilities are less constrained, employing multiple active models can lead to better overall system performance, particularly in scenarios with high variability in channel conditions or input data.

When the gNB instructs the UE to collect data for a specific purpose, such as the development of a training dataset, the gNB may also indicate that all collected data examples meet certain criteria. In such cases, the gNB may assign a specific data set ID to the UE before the data collection phase begins. The data set ID may ensure that all collected data share the same properties and can be grouped together for a particular application or training task.

All data collected under the same data set ID may have uniform characteristics. For instance, the data may be obtained from RSs, such as CSI-RS, that are all preceded by the same precoder. Additionally, the data may be transmitted using the same transmission reception point (TRP) schemes, whether it is a single TRP or multi-TRP configuration. Furthermore, the gNB can specify that the data for a given data set ID be transmitted from a particular set of TRPs. For example, data set ID #1 might be associated with TRP #1 and TRP #2, data set ID #2 with TRP #3 and TRP #4, and data set ID #3 with TRP #5.

This structure allows the UE to organize and collect data in a manner that ensures consistency and reliability within each dataset. By associating collected data with specific IDs and configurations, this data collection procedure may ensure that the data used for training accurately reflects the conditions and scenarios for which the models are intended.

In the context of AIML applications, it is not always the case that a trained AIML model will perform effectively for the entire duration of its deployment. In fact, the model may require frequent updates to adapt to temporal changes in the environment, such as statistical variations in the wireless channel. This is particularly relevant in scenarios like CSI compression using AIML, where the channel conditions can change over time. Consequently, a management framework may be needed to ensure that the model can be updated efficiently and in a timely manner, while maintaining reasonable overhead.

To facilitate such a framework, one consideration is model monitoring, where a network node keeps track of the AIML model's performance. This monitoring can be based on several performance metrics, which are categorized into two main types: task-based metrics and system-based metrics. Task-based metrics directly evaluate the performance of the specific task handled by the AIML model, such as accuracy or mean square error (MSE). System-based metrics, on the other hand, are derived from the overall performance of the system, such as successful decoding of transmissions or other system-level key performance indicators (KPIs).

When the performance of the ML model falls below acceptable levels based on one or more of the agreed or configured metrics, the management framework can initiate a model update procedure. The performance can be deemed unacceptable if it does not meet the configured metrics or if it remains unacceptable for a specific duration exceeding a predefined threshold. This threshold can be configured as a parameter or specified within the framework. Furthermore, the duration of unacceptable performance can be measured in two ways: (i) accumulative, where any duration of unacceptable performance is added to a global counter and compared to the threshold, or (ii) contiguous, where only a continuous duration of unacceptable performance greater than the threshold is considered.

When the model's performance is found to be inadequate, the management framework may trigger an update procedure in one of several ways. The first option is to perform a full training procedure, where the ML model is either re-trained from scratch or re-trained starting from the current ML model, using the entire dataset along with additional data samples that may have been recently acquired. Alternatively, the framework may require partial training, where the model is re-trained starting from the current ML model and using only new data samples recently obtained.

The general framework for CSI prediction operates as follows. A CSI prediction model is deployed at the UE for use during the inference phase. The UE estimates the downlink channel based on CSI-RS reception at specific time instances, such as t₁, . . . , t_{K-1}, and feeds the resulting K channel matrices (possibly after post-processing) into the prediction model. The model then estimates the CSI at time t_{K}, and the predicted CSI is reported as UCI to the gNB through an uplink channel transmission at a different time tᵣₑₚₒᵣₜ, for example, using the PUCCH. This reporting time may occur before or after the prediction time t_{K}.

For example, if the predicted CSI is transmitted to the gNB in slot n, the UE can be configured with a window in terms of the number of slots, where the UE receives the CSI-RSs in some or all slots according to the CSI-RS configuration. This window may start from slot l and end in slot l+W−1. Additionally, the UE may be provided with a CSI-RS reference slot n_{ref}: The starting time of the window, denoted as l, may be determined based on the report slot n, where 1=n+Δ, and Δ is an RRC-configured parameter. With this configuration, the model input includes CSI-RS measurement information collected in slots l to n_{ref}: The model then outputs the predicted CSI for the entire window or for only a subset of slots n_{ref}+1, . . . , l+W−1. Thus, the UE may report the CSI for the entire window in a report transmitted in slot n.

Within this framework, the predicted CSI can include either (a) only the precoder (i.e., RI and PMI) or (b) other CSI parameters, such as CQI. If only the precoder is predicted, the UE may employ a non-AIML-based CSI calculation routine to derive the predicted CSI parameters, such as CQI, using the AI-based predicted precoder. Alternatively, the AIML model can be configured to jointly predict all of these CSI parameters, providing a more comprehensive prediction result.

In order to differentiate AIML-based CSI prediction from other CSI reports, the CSI report configuration may be updated to include additional information. This additional information may include an indication that the reported CSI is based on AIML prediction. Such an indication may allow the gNB to apply the use of an AIML model at the UE. The indication may serve two purposes. First, it can ensure that AIML models are being used at the UE for CSI prediction, which may be required for certain performance evaluation or test procedures, such as those defined by radio access network working group 4 (RAN4). Second, the indication of AIML usage may allow for complexity management at both the UE and the gNB. For example, the gNB can ensure that all AIML-based CSI report configurations satisfy a maximum CSI processing unit limit dedicated to AIML CSI reports. This information can facilitate managing processing requirements for AIML models and ensures compatibility with predefined complexity constraints.

The updated CSI report configuration may also include an indication of the observation window for AIML-based CSI prediction. The observation window may be a parameter that defines the set of CSI-RS time intervals used by the UE to generate the predicted CSI. Indicating the observation window allows the gNB to change the observation window dynamically, particularly if the gNB performs performance monitoring instead of the UE. The gNB can evaluate the performance of the observation window based on performance metrics and indicate to the UE whether the observation window needs to be adjusted if the metrics are below a predefined threshold.

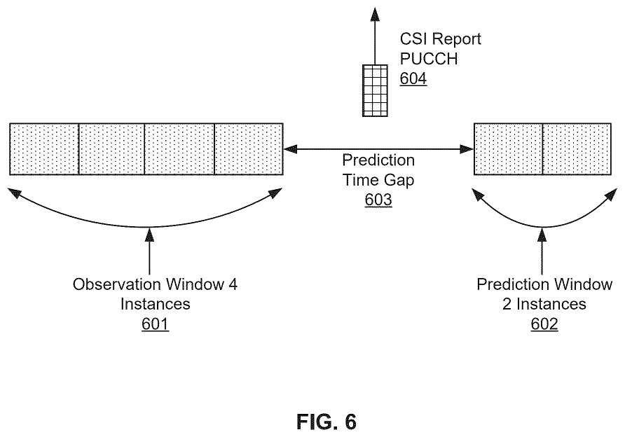

FIG. 6 is a diagram illustrating an example of using an observation window and prediction window in AIML CSI prediction, according to an embodiment.

Referring to FIG. 6, the observation window 601, represented by four instances (e.g., time instances), defines the number of consecutive CSI-RS transmissions used as input to the AIML prediction model. The prediction window 602 includes two instances, indicating the number of time intervals for which the UE predicts the CSI. Between the observation window and the prediction window, there is a prediction time gap 603 that separates the last CSI-RS instance in the observation window from the first instance of the prediction window. The prediction time gap 603 allows the AIML model to predict future CSI values based on past CSI measurements. The CSI report is then transmitted via the PUCCH 604 at a specified reporting time.

In the context of AIML-based CSI prediction, a functionality can be defined as an RRC configuration that includes information elements (IEs) specifying the parameters required for model inference. Each functionality may encompass various time-domain parameters related to prediction, such as the observation and prediction window or slot intervals, and may link to a CSI report configuration ID or include all the IEs defined in a CSI report configuration. Accordingly, a functionality can be understood as a CSI report configuration that integrates both known-configurations and AIML-related parameters. Each functionality may uniquely define the time and frequency domain resources used for CSI measurement and prediction, as well as the uplink report slot once it is activated by RRC, MAC-CE, or DCI signaling.

Table 1, below, shows some examples of functionalities and their configurations:

TABLE 1

| | |
|---|---|
| Functionality #1 | Parameters with a first set of values for defining the prediction |
| | window, e.g., N₄, d, l either explicitly or implicitly based on an RRC |
| | configuration, time domain and frequency domain resources and/or |
| | other information for the CSI report (can be a reference to a first CSI- |
| | report configuration ID). |
| Functionality #2 | Parameters with a second set of values for defining the prediction |
| | window, e.g., N₄, d, l either explicitly or implicitly based on an RRC |
| | configuration, time domain and frequency domain resources and/or |
| | other information for the CSI report (can be a reference to a second |
| | CSI-report configuration ID). |
| . . . | |
| Functionality #N | Parameters with a N-th set of values for defining the prediction |
| | window, e.g., N₄, d, l either explicitly or implicitly based on an RRC |
| | configuration, time domain and frequency domain resources and/or |
| | other information for the CSI report (can be a reference to an N-th |
| | CSI-report configuration ID). |

The concept of a “functionality” may not be explicitly defined in the NR configurations and may effectively serve the same purpose as the CSI report configuration, with the addition of AIML-related features. Each configured functionality can be assigned a unique functionality ID, which allows the gNB to activate, deactivate, or switch between different functionalities using DCI, MAC-CE, or RRC configurations. If a functionality definition refers to or directly defines a CSI report configuration, it can be associated with periodic, SP, or AP CSI reporting modes.

For functionalities with periodic CSI report configurations, activation can occur through a DCI indication, MAC-CE command, or RRC configuration. DCI indications to a set of functionality IDs or CSI report configurations can be reused for activation. Once the functionality is configured via RRC, it is considered active, and the UE should report the corresponding CSI by performing model inference. In this case, functionality deactivation or release occurs through the RRC release of the configured functionality. For functionalities with SP CSI report configurations, activation can occur via a DCI indication or MAC-CE command. DCI indications to a set of functionality IDs or CSI report configurations can be reused for activation, and the MAC-CE command timeline can be used to activate or deactivate the functionality. For functionalities with AP CSI report configurations, DCI indications to a set of functionality IDs or CSI report configurations can also be reused for activation.

Once the UE reports its conditions for supporting AIML features, the gNB may configure multiple functionalities for the UE via an RRC. Depending on the UE's implementation, the UE can have one model for each functionality, multiple models for the same functionality, or one model shared across multiple functionalities to perform inference. Since the complexity of the UE's AIML implementation is closely related to the number of active or stored models, the UE should report its capability to indicate conditions related to the number of stored or active models. These capability reports can help define boundaries within which the UE is expected to operate different models for inference.

The gNB can manage these capabilities by configuring and activating functionalities based on the reported constraints, ensuring that the UE operates within its computational and memory limitations while supporting the required AIML functionalities for CSI prediction and reporting.

To define the boundaries for the number of active models and functionalities, the UE can report its capability in handling different configurations to the gNB. According to a first boundary approach, the capability reporting may be divided into two phases, referred to as phase 1 and phase 2. In phase 1, which occurs before functionality configuration, the UE reports the maximum number of functionalities for CSI prediction that the gNB can configure. This is represented by the parameter X_{config}. For each AIML use case, the UE provides X_{config} as the upper limit for the number of functionalities the gNB can set. If the gNB configures n CSI prediction functionalities, it must ensure that n≤X_{config}.

The UE may also report the maximum number of active, simultaneous models it can support during the inference phase, denoted as X_{active}. If the gNB activates n functionalities, it must ensure that n≤X_{active}.

In phase 2, which occurs after functionality configuration, the UE may report its capability to perform inference for the configured functionalities. This capability reporting can vary depending on how the UE handles the inference process for each functionality. One phase 2 scenario involves the UE using multiple models for a single functionality. For example, the UE may have one model for low Doppler and another for high Doppler scenarios. In this case, the UE may require additional processing time to switch between models, depending on the detected scenario. The UE can report the required relaxation time as a UE capability, which may be represented as a number of symbols with reference to the subcarrier spacing (SCS).

Another phase 2 scenario involves the UE using a single model to perform inference for a group of functionalities. This is possible if the UE trains a single model to handle different scenarios. For instance, if the UE has trained a model to support different combinations of observed CSI-RS and predicted CSI parameters, and the gNB configures two functionalities, each corresponding to one combination, the UE can group these functionalities and report its capability to use one model for both. In this case, the UE may signal the group configuration using a bitmap, where each group of functionalities is represented by a separate bit. If the gNB switches functionalities within the same group, no additional processing time is needed. However, if the gNB switches functionalities between different groups, the UE may need a specified switching time to perform the model switching.

If the UE does not provide any specific report regarding grouping or multiple models, it is assumed that the UE runs a separate model for each configured functionality. In such a scenario, the gNB should ensure that sufficient processing time is provided when switching between functionalities, similar to the time needed for switching between groups of functionalities.

Once the gNB activates functionalities, the number of activated functionalities may be calculated based on the UE's phase 2 report. For example, if the gNB activates a functionality for which the UE reports two models, that functionality is counted twice. Similarly, if the gNB activates one or more functionalities from a group for which the UE reported using only one model, regardless of the number of activated functionalities in that group, the count will be considered as one. For instance, if the UE is configured with four functionalities and declares that it uses two models for functionality #1 and one model for the set of functionalities #2, #3, and #4, then if the gNB activates all four functionalities, the count is 1+1=2. This total count should not exceed X_{active,total}.

Another boundary approach (a second boundary approach) for considering UE constraints on the number of models and inference complexity with functionality-based lifecycle management (LCM) is for the UE to define, in its capability reports, the conditions under which it can perform AIML inference using a single model. These conditions are referred to as “boundary conditions”. A boundary condition may specify the scenarios in which a single model can be used, irrespective of the number of configured functionalities within that boundary. Based on the reported boundary conditions, the gNB may configure functionalities such that each functionality falls within one boundary condition. Each configured functionality should satisfy one and only one boundary condition, and the gNB may not be allowed to configure a functionality that does not meet any of the boundary conditions specified by the UE.

For example, a UE can declare boundary conditions based on different CSI prediction window parameters and CSI report configurations. The following are some example boundary conditions, as shown below in Table 2:

TABLE 2

| | |
|---|---|
| Boundary condition #1 | CSI prediction window parameters condition 1, CSI report config#1 |
| | with sub-band configuration condition 1 |
| Boundary condition #2 | CSI prediction window parameters condition 2, CSI report config#1 |
| | with sub-band configuration condition 2 |
| Boundary condition #3 | CSI prediction window parameters condition 3, CSI report config#1 |
| | with sub-band configuration condition 3 |

The gNB should configure functionalities such that each functionality falls within one of these boundary conditions. Similar to the first mentioned boundary condition approach, the number of configured or activated functionalities should satisfy the maximum number defined by X_{configur,total} and X_{active,total}. The difference is in the way functionalities are counted. For this approach, all configured functionalities within a single boundary condition may be counted only once. This allows the gNB to optimize the number of active models by grouping functionalities that meet the same boundary conditions.

The UE may also include additional criteria within the boundary conditions, such as Doppler levels or other environmental conditions. As an example, boundary conditions with additional parameters could include the following boundary conditions shown in Table 3:

TABLE 3

| | |
|---|---|
| Boundary condition #1 | CSI prediction window parameters condition 1, CSI report config#1 |
| | with sub-band configuration condition 1, Low Doppler |
| Boundary condition #2 | CSI prediction window parameters condition 1, CSI report config#1 |
| | with sub-band configuration condition 1, High Doppler |
| Boundary condition #3 | CSI prediction window parameters condition 2, CSI report config#2 |
| | with sub-band configuration condition 2, Low Doppler |
| Boundary condition #4 | CSI prediction window parameters condition 2, CSI report config#2 |
| | with sub-band configuration condition 2, High Doppler |
| Boundary condition #5 | CSI prediction window parameters condition 3, CSI report config#3 |
| | with sub-band configuration condition 3, Low Doppler |
| Boundary condition #6 | CSI prediction window parameters condition 3, CSI report config#3 |
| | with sub-band configuration condition 3, High Doppler |

In cases where the additional condition (e.g., Doppler level) is only known to the UE, if the gNB configures or activates a functionality, that functionality may be counted twice towards the number of configured or activated functionalities. This ensures that the gNB considers the extra complexity associated with different Doppler levels when managing the number of active models.

According to another boundary condition approach (a third boundary approach), the boundaries are defined similarly to the second boundary approach. The primary difference is that, in the second boundary approach, the boundary conditions are defined and declared by the UE through capability signaling. However, in the third boundary approach, the boundaries are predefined configurations, without any signaling required from the UE. This standardization of boundary conditions ensures consistency across different UEs and simplifies the management of functionalities for the gNB.

Even when the UE operates a single AIML model for multiple active functionalities, the simultaneous execution of inference operations may introduce additional computational complexity. In some NR systems, a CSI processing unit is defined, and the UE reports its capability in terms of the maximum number of CSI processing units it can run simultaneously. The behavior of the UE is also defined for situations where a CSI report requires more CSI processing units than the number currently available. In the context of AIML, a “CSI processing unit” refers to a dedicated processing unit used exclusively for AIML functionalities.

The UE may report the maximum number of CSI processing units it can support for AIML features, denoted as N_{CPU}^{AI/ML}. Each active CSI prediction functionality may occupy a certain number of CSI processing units, denoted as O_{CPU}. The value of O_{CPU} can be declared as a UE capability, configured through RRC signaling, or specified within an NR configuration. This value may differ from one used for CSI report configurations. The CSI processing unit occupation behavior in this context can reuse a configuration's behavior depending on the activation signaling method employed.

Similar to configurations where each CSI report corresponds to a functionality, the AIML functionality can have its own priority level. The priority level may be determined based on whether the CSI is periodic, SP, AP, or transmitted via PUCCH or PUSCH. The priority could also be based on the serving cell index or other parameters. Additionally or alternatively, a new priority level may be introduced specifically for AIML-predicted CSI. In addition, a higher priority level (lower priority index) may be assigned to AIML-predicted CSI reports since they are needed by the gNB for low-latency, high-reliability downlink assignments. In one embodiment, the AIML-predicted CSI may be given a higher priority compared to other CSI reports. If other CSI and AIML CSI are multiplexed within the same uplink channel, the AIML-predicted CSI may be assigned a higher priority. Otherwise, the priority levels may be assigned similarly to other configurations, but only among the AIML CSI reports and functionalities.

The UE's behavior for updating CSI reports may follow predetermined configurations. For example, if N functionalities occupy their respective CSI processing units on the same OFDM symbol, and the number of currently unoccupied CSI processing units is N_{CPU}^{AI/ML}−L, where each functionality n=0, . . . , N−1 corresponds to O_{CPU}⁽ⁿ⁾ occupied CSI processing units, the UE may not be required to update the N−M CSI reports corresponding to the N−M functionalities with the lowest priority. In this case, 0≤M≤N may be the largest value such that the total CSI processing units occupation across the M functionalities satisfies Σₙ₌₀^{M-1} O_{CPU}⁽ⁿ⁾≤N_{CPU}^{AI/ML}−L. This condition ensures that the number of CSI processing units occupied does not exceed the number of available CSI processing units for AIML operations.

In a model ID-based LCM framework, models may be identified and registered with the network. Each identified logical model reported to the gNB may correspond to a distinct physical model at the UE. It is assumed that there is a one-to-one relationship between the logical model IDs and the physical models, meaning that the UE does not register two logical models that correspond to the same physical model. However, a single logical model can represent multiple distinct physical models. For example, the UE might have both a low-complexity model and a high-complexity model for the same AIML feature or functionality. Once models are identified, the UE may report to the gNB which models it supports.

In the context of model ID-based LCM, concerns about the number of supported models, as seen in functionality-based LCM, may be less significant. Nevertheless, one aspect that should be considered is the potential for multiple physical models to correspond to a single logical identified model. This can be addressed within the UE capability report, as the UE is aware of this condition and can adjust its capability report accordingly.

For the capability reporting, the UE may signal to the gNB which models among the identified models it supports. This signaling may include two parts. The first part may include a UE vendor ID, while the second part may provide the indices of the supported models identified by the UE vendor. If the UE vendor identifies N models to the gNB, this part of the report can be represented as a bitmap of length N, where each of the N elements corresponds to one identified model, arranged in either ascending or descending order based on the model ID. From the perspective of the gNB and the UE, once the vendor is identified, the identified models may be assigned local logical IDs from 0 to N−1. The UE then may then declare its support for specific models using this bitmap.

In addition to indicating which model IDs are supported, the UE may also declare its capability in terms of the maximum number of simultaneous activated models, denoted as N_{active,max}. The UE may not expect the gNB to activate more than N_{active,max} models at the same time. To account for additional complexity due to the possibility of running multiple physical models for the same logical model, the UE may also report a scalar value αᵢ>1 for each supported model ID i. This scaling factor αᵢ can also be communicated to the network during model identification. Consequently, the UE may not expect the gNB to activate more than N_{active,max} models simultaneously, where the number of activated models is calculated considering the scaling factor αᵢ. If the gNB activates models with IDs in the set ⊂{0, . . . , N−1}, the number of activated models may be calculated as Σ_{i∈S} αᵢ, which the UE expects not to be greater than N_{active,max}.

Accordingly, this approach may allow the gNB to manage the complexity and computational load on the UE while taking into account the nature of physical model implementations and their corresponding logical model identifiers.

The type of information that is revealed to the network when a model is identified may be referred to as meta information. The meta information can vary depending on the specific implementation, and there are different possibilities for what it may include.

In one embodiment, the meta information encompasses all necessary parameters required for model inference. In this scenario, when the gNB activates a certain model ID, it is equivalent to performing all RRC configurations needed for inference. This means that when the gNB activates a model ID, it effectively activates a specific CSI report configuration. In the NR system, the CSI report configuration may include details such as sub-band configuration, codebook type, and other parameters. All of this information may be incorporated into the meta information. This approach reduces RRC overhead because the meta information consolidates all the necessary configuration details, simplifying the signaling process. However, it limits the gNB's flexibility since every functionality or RRC configuration would need to be established through model identification. Furthermore, a network device other than the gNB may directly configure the meta information, which could result in less control over certain configurations.

In another embodiment, the meta information may co-exist with the RRC configuration. Using CSI prediction as an example, the gNB can configure a CSI report along with the necessary prediction parameters, such as the monitoring and prediction window. The gNB can also indicate a model ID to the UE to match the current additional conditions or environment. This allows for greater flexibility in adapting to changing scenarios and configurations, while still leveraging the RRC framework for core configuration tasks.

Additionally, the possibility of the AIML CSI prediction co-existing with the CSI report should be considered. Although the computational complexity of AIML-based CSI prediction is different from that of the CSI report due to the need for model inference, this additional complexity can be managed through the UE's capability reporting. Specifically, the capability report can include parameters such as the number of active models, the maximum number of AIML-specific CSI units N_{CPU}^{AI/ML}, and the functionality-specific number of occupied CSI processing units. With these accommodations in place, the simultaneous configuration and activation of both CSI and AIML-predicted CSI functionalities on the same serving cell may be avoided.

The UE can be configured to support both CSI reporting and AIML-based CSI prediction functionalities simultaneously within a serving cell. In such cases, the UE may report both the CSI and the AIML-predicted CSI in the designated uplink channels independently. If the uplink channels for the legacy CSI and the AIML-predicted CSI overlap, the UE may multiplex them in the same channel using a multiplexing procedure. In scenarios where CSI omission is necessary, the priority of the AIML-predicted CSI may be considered when deciding which CSI reports to omit. This ensures that the AIML-predicted CSI is prioritized over the CSI report.

In NR systems, the UE may report various CSI parameters, including CRI, RI, PMI, CQI, and layer indicator (LI). The reported CSI parameters may be determined through a CSI report configuration, which may include a subset of these parameters. The CSI report configuration can be reused to facilitate this process.

The gNB may configure the UE using a CSI prediction report configuration or reuse the report configuration. The gNB can indicate which specific CSI parameters are to be predicted and reported by the UE. For example, the UE may be configured to report CRI, RI, PMI, and/or CQI through the CSI report configuration, while only reporting the predicted RI or PMI through the predicted CSI report. This flexibility allows for the seamless integration of predicted CSI parameters into the framework, enabling the network to adapt to different reporting requirements based on the use case and the channel conditions.

Once the UE reports its supported scenarios through capability reporting, the gNB may configure the UE with a number of functionalities using RRC signaling. These functionalities can then be selected, activated, or deactivated by the gNB. For each AIML functionality, the UE may utilize a prediction model for inference, or it may use the same model for multiple functionalities. During the LCM process, the gNB can perform various operations to ensure proper configuration and operation of these functionalities.

The gNB may indicate dynamically or via RRC signaling for the UE to switch from AIML-based CSI prediction to traditional CSI reporting. This allows the network to seamlessly transition between different reporting methods as needed. The CSI reporting and AIML-based CSI prediction can co-exist simultaneously through different report configurations. This enables the network to maintain flexibility in managing and utilizing different CSI reporting methods.

The gNB can configure the UE with an offset that determines the prediction time offset. The offset may represent the time between the latest measured CSI-RS and the time at which the CSI is predicted (referred to as the prediction time). The prediction time may or may not coincide with the start time of the uplink transmission carrying the predicted CSI report. In one embodiment, for each prediction CSI uplink channel, the gNB can indicate to the UE which specific prediction time should be reported in the scheduled uplink channel. This ensures that the reported CSI accurately reflects the predicted channel conditions at the appropriate time.

The input to the CSI prediction model may be left to the UE to decide how many CSI-RS resources, and at which times, should be used to estimate the CSI at a given target prediction time. This flexibility allows UEs to optimize their prediction models based on their capabilities and the current channel conditions, resulting in more accurate and reliable CSI predictions.

Data collection for AIML model training and inference can be initiated and controlled through signaling between the UE and the gNB. Although data collection may be carried out by the UE transparently, the process can be optimized to match the CSI-RS pattern configuration, periodicity, and other parameters with the training and inference requirements of the AIML model. To facilitate this alignment, the UE may send a request to the gNB, via a 1 bit UCI transmission, to start the transmission of CSI-RS that is tailored for a specific training or inference scenario. The UE may also indicate the proprieties of the model it wants to train. For example, if the UE intends to train a prediction model using a window of N₄ slot intervals, each of length d, it can request the gNB to initiate periodic CSI-RS transmissions that are aligned with this training scenario. Additionally or alternatively, the UE can notify the gNB that it wants to train a model with an observation window of N_{obs}=3 and a prediction window of Nₚᵣₑ=2. This configuration specifies that the observation window is 3 slots and the prediction window is 2 slots. The UE may also indicate a distance between prediction RS slots and/or a gap between the observation window and the prediction window.

Upon receiving the UE's request, the gNB can trigger a data collection session through a DCI, MAC-CE, or RRC configuration of a dedicated CSI report configuration. This configuration can be used to initiate and control the data collection process according to the requirements specified by the UE. The gNB can then configure the CSI-RS resource sets specifically for data collection purposes. In such cases, the UE may not be required to report CSI for the corresponding configuration. On the other hand, the gNB may configure CSI-RS resource sets solely for the purpose of data collection, without any corresponding CSI report by the UE. These CSI-RS resources should match the training scenario defined by the UE. For example, they can be transmitted with a periodicity of d slots and over a number of slot intervals that is at least N₄.

In some cases, data heterogeneity can degrade the performance of AIML models. Specifically, if a single model is developed using a dataset that is a mixture of different distributions, it is likely to perform worse when tested on a specific distribution compared to a model that has been trained exclusively on that distribution. Therefore, it is ideal for the UE to train separate models for each distribution represented in the test data. In AIML-based CSI prediction, the data input to the model may include the CSI-RS channel measurements, such as estimated channel matrices. The distribution of these channel matrices over sub-bands and time intervals may be influenced by channel properties like delay spread, which affects frequency domain correlation, and Doppler spread, which affects time domain correlation, among other factors.

While some of these parameters can be known to the UE, enabling it to classify the data into different categories, train different models, and select the appropriate one for inference, it may not always be straightforward for the UE to identify distinct distributions. This is especially challenging when the different distributions arise due to variations in gNB implementations. For example, if a gNB uses a different downlink beam codebook for the same antenna configuration, the channels measured by the UE would correspond to different distributions. To facilitate the UE's development of distribution-specific models for various gNB implementations, scenarios, and conditions, the gNB can provide an identifier to the UE, referred to as a data set ID, additional condition ID, scenario ID, associated ID, assistance information ID, or assistance information.

Collected data associated with different IDs may be presumed to belong to different distributions, enabling the UE to develop separate models for each ID. The gNB may provide the UE with an identifier that reflects the specific vendor of the gNB. A predefined pool of gNB vendors may be considered offline, each assigned a unique ID. This indication can be transmitted to the UE through system information, a CSI-RS, a CSI report configuration, or a dedicated RRC parameter. The gNB vendor ID may help the UE differentiate between implementation-specific variations associated with different vendors.

Additionally, the gNB may configure specific CSI-RS resources, sets, or reports with an identifier that corresponds to a particular gNB implementation. The gNB may or may not specify to the UE which aspect of the gNB implementation the identifier reflects. For instance, the gNB could specify that a unique ID is linked to a specific analog beam codebook, which helps the UE distinguish between different transmission configurations. By providing these identifiers, the gNB may assist the UE in classifying and segmenting the collected data according to their respective distributions. This segmentation may enable the UE to train distinct models for each unique distribution.

For the purpose of data collection and model training, scenario-specific models may be expected to outperform generic models that are used for all possible scenarios. To enable the UE to categorize data for training its model, the gNB may indicate the data category in the RRC configuration of the CSI-RS, including parameters such as antenna configuration, single TRP, multi-TRP scheme, and other relevant information. This indication can be provided in the RRC configuration of the CSI-RS as shown below.

| | |
|---|---|
| ZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| scramblingID | ScramblingId, | |
|---|---|---|
| periodicityAndOffset | CSI-ResourcePeriodicityAndOffset | OPTIONAL, |

-- Cond PeriodicOrSemiPersistent

| | | |
|---|---|---|
| qcl-InfoPeriodicCSI-RS | TCI-StateId | OPTIONAL, -- |

```
Cond Periodic
  -- Data category ID
    ...
  }
```

The gNB may associate a CSI-RS resource with a specific data category ID (category ID) to facilitate categorization. As mentioned above, the ID may also be referred to as “assistance information” and may include the vendor ID. Each CSI-RS resource within a resource set may be associated with the same category ID. The category ID may indicate different deployment scenarios, such as urban macro (Uma) or urban micro (UMi). The gNB may dynamically indicate the category ID to the UE through MAC-CE signaling. This allows the gNB to specify different deployment scenarios or configurations for subsequent CSI-RS transmissions, ensuring that the UE can categorize and utilize the data accordingly.

Data collection may be performed autonomously by the UE without any explicit indication to the gNB, or it may be triggered by the gNB itself. The gNB may send a data collection command to the UE via DCI or MAC-CE signaling. Upon receiving the command, the UE is expected to start collecting data after an application time T_{collection,command}, which is measured from the ending symbol of the downlink channel that carries the data collection command. CSI-RS transmitted after the duration T_{collection,command} may be considered valid for data collection.

The gNB may also specify the length of the input data required for the model, indicating the number of CSI-RS instances or time intervals used to obtain the input data for model training. Additionally, the gNB can provide a time offset for the predicted data, which is measured from the last CSI-RS used as input to the model and the time at which the CSI is predicted. This allows the gNB to precisely control the timing and nature of data collection, ensuring that the collected data is aligned with the training requirements of the AIML model.

Data collection can also be initiated by the UE through a request command. Upon receiving such a request, the gNB can trigger the collection session as described above. The UE may send the data collection request using a data collection request (DCR) message, which can be transmitted through various channels such as the PUCCH as part of UCI, or via the uplink data channel. The DCR message can also be multiplexed with other uplink control information, similar to how scheduling requests are handled. For example, the DCR can be transmitted using a specific scheduling request (SR) configuration. When multiplexed with other PUCCH or PUSCH transmissions, a dedicated SR configuration index can be used to indicate the DCR request, which can be configured through RRC signaling.

Accordingly, the UE can develop specialized models for different scenarios, thereby improving the overall performance and accuracy of AIML-based CSI prediction.

In addition to configuring the time offset between the last CSI-RS and the prediction time, the gNB may bundle K CSI-RS resources, with each resource transmitted at different time instances. The dataset may be collected such that the first K CSI-RS resources may be used to generate the input for the prediction model, while the last CSI-RS may be used to obtain the ground-truth CSI at the prediction time, which corresponds to the time at which the last CSI-RS is transmitted. This configuration ensures that the collected data accurately reflects the channel conditions at the prediction time.

The gNB may also provide multiple bundles with different prediction offset time values, allowing for variations in the prediction time relative to the last measured CSI-RS. The bundles can differ in terms of the time intervals between the K−1 measurement CSI-RS resources, providing flexibility in how the CSI is measured and used as input for the prediction model. The time domain properties of both the measurement and ground-truth CSI-RS resources can be configured via RRC signaling, enabling precise control over the timing and configuration of CSI-RS transmissions for data collection.

Once a model is activated for a CSI prediction functionality, performance monitoring may be required to enhance system performance by allowing for the deactivation, switching, or activation of models. In a general monitoring framework, since the inference takes place at the UE side, it is logical to assign the task of performance monitoring to the UE. The UE may calculate a performance metric, such as key performance indicators (KPIs) like test loss, and then report the calculated metrics to the gNB. Based on these reports, the gNB can decide whether to keep the current model active or to instruct the UE to revert to the non-prediction-based CSI reporting. There are several methods available for implementing performance monitoring.

In a first performance monitoring method, the UE calculates the performance metrics and then reports these metrics to the gNB. The gNB, in turn, makes the LCM decision based on the reported values. This approach centralizes decision-making at the gNB, which can then optimize the network's performance by managing the active models according to the metrics received from the UE.

In a second performance monitoring method, the UE reports both the predicted CSI and the ground-truth CSI to the gNB, which then calculates the performance metrics itself. This method shifts the burden of performance metric computation to the gNB, allowing it to have direct control over the evaluation and decision-making process for LCM.

In a third hybrid performance monitoring method, the UE calculates the performance metric and provides a simplified description of the metric to the gNB based on a predefined event. The gNB then uses this information to make LCM decisions.

The metric can be based on several different methods. One such metric method involves using a threshold-based approach for a single instance. In this method, the gNB configures the UE with a specific threshold value. The UE then calculates the performance metric and reports only whether the metric is above or below the configured threshold. This is done by sending a binary indication, where a value of “1” indicates that the metric is above the threshold, and a value of “0” indicates that the metric is below the threshold.

Another metric method involves using a threshold-based approach over multiple instances. In this method, the UE calculates the binary value as described above. However, instead of reporting the value based on a single instance, the UE counts the number of times the calculated metric exceeds the threshold within a configured time window or duration. If this count exceeds another threshold value, which is an integer that can be configured by the gNB, the UE may report this information to the gNB as a binary value. This indicates whether the model has failed from a performance standpoint based on cumulative evaluations over the specified time window.

The performance metric can be reported to the gNB after quantization through an uplink channel. The gNB may configure the quantization parameters for the UE, including the number of bits used for reporting and the quantizer function itself, such as the threshold values. Once quantized, the metric can be transmitted to the gNB through either the PUSCH or PUCCH channels as a UCI message.

In the case of applying binary reporting for the third hybrid performance monitoring method, if the reporting follows the single instance threshold based approach, a single bit of information can be transmitted in the PUCCH. This allows for efficient transmission of the binary indication regarding whether the performance metric is above or below the threshold. If the reporting follows the multiple instances threshold based approach, a mechanism similar to an SR or link recovery request (LRR) can be used. Specifically, PUCCH resources can be configured and dedicated for this purpose. The gNB may then perform blind detection to determine whether the UE has reported an exceeding count event, indicating that the model has failed to meet the required performance metrics over the specified time window.

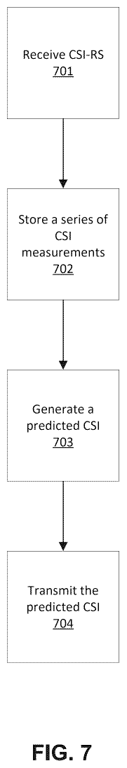

FIG. 7 is a flowchart illustrating a method for AIML based CSI prediction, according to an embodiment.

The steps in the flowchart of FIG. 7 may be performed by a UE, an electronic device, or any other network device. Referring to FIG. 7, in step 701, the UE receives a CSI-RS from a base station. Although only a single CSI-RS is mentioned in this step, this step is intended to cover the UE receiving a plurality of CSI-RSs as well.

In step 702, the UE stores a series of CSI measurements corresponding to the received CSI-RS. Also, in the case in which a plurality of CSI-RSs are received, then the UE is capable of storing a series of CSI measurements for each CSI-RS included in the plurality of CSI-RSs.

In step 703, the UE generates a predicted CSI based on the stored CSI measurements using a trained AIML model. The AIML model may be trained according to one or more of the embodiments discussed above. In addition, the CSI may be predicted based on a CSI report configuration received by the UE.

In step 704, the UE transmits the predicted CSI to a base station or any other network device.

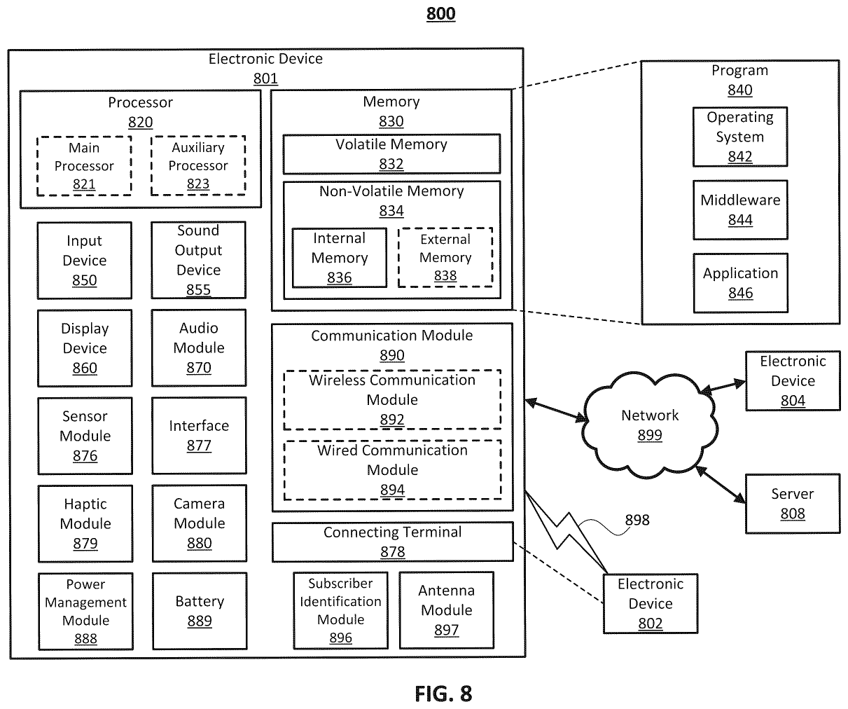

FIG. 8 is a block diagram of an electronic device in a network environment, according to an embodiment.

Referring to FIG. 8, embodiments disclosed herein utilize various components of the electronic device 801 to implement an AIML-based CSI prediction and/or signaling procedure, enhancing the communication between the UE and the network. The processor 820, in conjunction with the memory 830, can execute an AIML prediction model to process a series of CSI measurements received by the communication module 890. This configuration enables the electronic device to perform real-time CSI prediction using stored measurements, facilitating more accurate channel state reporting. By using the AIML model, the system significantly reduces prediction errors compared to traditional methods, improving system throughput and efficiency.

Additionally, the technical improvements provided by one or more embodiments include optimized usage of computational resources such as the NPU, which may be included in or separate from the processor 820, and more efficient data handling within the memory 830. The NPU can handle complex AIML computations required for CSI prediction, reducing computations required by the main processor 820 and reducing latency. Furthermore, the communication module 890 can support multiple report configurations, including non-AIML-specific configurations and AIML-specific configurations, allowing the device to dynamically switch based on the network's requirements. This adaptability leads to enhanced performance and reduced power consumption, as the device can selectively activate AIML functionalities based on real-time conditions.

The electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor, and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

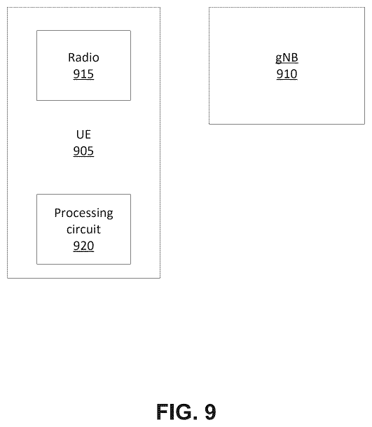

FIG. 9 is a block diagram illustrating a UE and a gNB included in an AIML prediction system, according to an embodiment.

Referring to FIG. 9, a UE 905 and a gNB 910 are in communication with each other. The UE may include a radio 915 and a processing circuit (or a means for processing) 920, which may perform various methods disclosed herein, e.g., the method illustrated in FIG. 7. For example, the processing circuit 920 may receive, via the radio 915, transmissions from the gNB 910, and the processing circuit 920 may transmit, via the radio 915, signals to the gNB 910.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE), comprising:
receiving, by the UE, a channel state information (CSI)-reference signal (RS) from a base station;
storing, by the UE, a series of CSI measurements corresponding to the received CSI-RS;
receiving, by the UE, a CSI report configuration including an indication that artificial intelligence machine learning (AIML) CSI prediction is applied;
in response to receiving the indication that AIML CSI prediction is applied, generating, by the UE, a predicted CSI based on the stored CSI measurements using a trained artificial intelligence (AI) machine learning (ML) model; and
transmitting, by the UE, the predicted CSI to the base station.

2. The method of claim 1, wherein generating the predicted CSI using the AIML model is based on the received CSI report configuration.

3. The method of claim 2, wherein the CSI report configuration further includes an indication of an observation window for the AIML model, the observation window defining a number of slots, starting from a first slot ending at a last slot, used by the UE to identify the series of CSI measurements.

4. The method of claim 2, wherein the CSI report configuration further includes an indication of a prediction window for the AIML model, the prediction window defining a number of slots, starting from a first slot ending at a last slot, used by the UE to identify one or more predicted CSI measurements.

5. The method of claim 1, further comprising:
transmitting, by the UE, a capability report indicating a maximum number of AIML-based CSI prediction functionalities that can be activated by the base station.

6. The method of claim 1, further comprising:
assigning, by the UE, a single AIML prediction model to multiple CSI prediction functionalities,
wherein the multiple functionalities satisfy a boundary condition defined by a CSI prediction window parameter.

7. The method of claim 6, wherein the boundary condition is determined based on an observation window parameter or a prediction window parameter, and
wherein the multiple CSI prediction functionalities that satisfy the boundary condition are counted as a single functionality.

8. The method of claim 1, further comprising:
transmitting, by the UE, a request to initiate a data collection session for CSI measurement;
in response to the request, receiving, from the base station, a CSI report configuration dedicated for data collection that is indicated by an explicit information element in the CSI report configuration or a report quantity of the CSI report configuration that is set to none,
wherein the request includes parameters indicating an observation window or a prediction window to be used for model training.

9. The method of claim 1, further comprising:
performing data collection based on assistance information including an associated identification (ID) of one or more CSI resource sets associated with a network implementation to match a data distribution during training with a data distribution during inference,
wherein each of the one or more CSI resource sets correspond to a unique associated ID.

10. The method of claim 1, wherein generating the predicted CSI further comprises generating the predicted CSI using a maximum number of CSI processing units reported by the UE supporting simultaneous CSI calculation and a number of occupied CSI processing units in response to a CSI report configuration that indicates use of the AIML model.

11. A user equipment (UE), comprising:
a memory device; and
a processor configured to execute instructions stored on the memory device, wherein the instructions cause the processor to:
receive a channel state information (CSI)-reference signal (RS) from a base station;
store a series of CSI measurements corresponding to the received CSI-RS;
receive, by the UE, a CSI report configuration including an indication that artificial intelligence machine learning (AIML) CSI prediction is applied;
in response to receiving the indication that AIML CSI prediction is applied, generate a predicted CSI based on the stored CSI measurements using a trained artificial intelligence (AI) machine learning (ML) model; and
transmit the predicted CSI to the base station.

12. The UE of claim 11, wherein generating the predicted CSI using the AIML model is based on the received CSI report configuration.

13. The UE of claim 12, wherein the CSI report configuration further includes an indication of an observation window for the AIML model, the observation window defining a number of slots, starting from a first slot ending at a last slot, used by the processor to identify the series of CSI measurements.

14. The UE of claim 12, wherein the CSI report configuration further includes an indication of a prediction window for the AIML model, the prediction window defining a number of slots, starting from a first slot ending at a last slot, used by the UE to identify one or more predicted CSI measurements.

15. The UE of claim 11, wherein the instructions further cause the processor to transmit a capability report indicating a maximum number of AIML-based CSI prediction functionalities that can be activated by the base station.

16. The UE of claim 11, wherein the instructions further cause the processor to:
assign a single AIML prediction model to multiple CSI prediction functionalities,
wherein the multiple functionalities satisfy a boundary condition defined by a CSI prediction window parameter.

17. The UE of claim 16, wherein the boundary condition is determined based on an observation window parameter or a prediction window parameter, and
wherein the multiple CSI prediction functionalities that satisfy the boundary condition are counted as a single functionality.

18. The UE of claim 11, wherein the instructions further cause the processor to:
transmit a request to initiate a data collection session for CSI measurement;
in response to the request, receive, from the base station, a CSI report configuration dedicated for data collection that is indicated by an explicit information element in the CSI report configuration or a report quantity of the CSI report configuration that is set to none,
wherein the request includes parameters indicating an observation window or a prediction window to be used for model training.

19. The UE of claim 11, wherein the instructions further cause the processor to:
perform data collection based on assistance information including an associated identification (ID) of one or more CSI resource sets associated with a network implementation to match a data distribution during training with a data distribution during inference,
wherein each of the one or more CSI resource sets correspond to a unique associated ID.

20. The UE of claim 11, wherein generating the predicted CSI further comprises generating the predicted CSI using a maximum number of CSI processing units reported by the UE supporting simultaneous CSI calculation and a number of occupied CSI processing units in response to a CSI report configuration that indicates use of the AIML model.
